(19) United States
(12) Patent Application Publication
(10) Pub. No.: US 2025/0061517 A1
(43) Pub. Date: Feb. 20, 2025

(54) VALUE BASED WEALTH RECOMMENDATION ENGINE FOR ADVISOR ACTION

(71) Applicant: Yodlee, Inc., Raleigh, NC (US)

(72) Inventors: Dhruv Sabharwal, Raleigh, NC (US); Atif Adib, Bangalore (IN); Om D. Deshmukh, Bangalore (IN); Vinay Manjunath, Bangalore (IN)

(21) Appl. No.: 18/235,266

(22) Filed: Aug. 17, 2023

(51) Int. Cl. G06Q 40/06

(52) U.S. Cl. CPC G06Q 40/06

(57) ABSTRACT

As described herein, a system, method, and computer program provide a value based wealth recommendation engine for advisor action. Financial transaction data associated with a financial management platform is accessed. The financial transaction data is processed in a probabilistic manner to generate one or more recommendations for financial management actions to be taken by a specified financial advisor for one or more clients of the specified financial advisor, wherein the one or more recommendations are personalized to the specified financial advisor. The one or more ranked recommendations are output.

### FIELD OF THE INVENTION

The present invention relates to processing financial data for financial wealth management.

### BACKGROUND

Financial advisors generally use a financial management platform to manage their clients' wealth and perform necessary actions associated with their holistic financial planning. These actions include (and are not limited to) making decisions for clients' retirement, tax, future expenses, financial goals, wealth creation, risk prevention, estate planning, portfolio management and more. In addition to the several decisions the advisor makes for the client daily, they need to manage client expectations and keep a healthy professional and engaged relationship with their clients.

Thus, while existing financial management platforms used by such advisors allow the advisors to manually select which actions to take in association with their clients' finances, these platforms are not configured to be able to recommend a next suitable action for a given client nor to be able to prioritize when an action should be recommended. As the advisors manage different clients with various requirements, automating these recommendations would be beneficial.

There is thus a need for addressing these and/or other issues associated with the prior art. For example, there is a need to provide a wealth recommendation engine for financial advisors.

### SUMMARY

As described herein, a system, method, and computer program provide a value based wealth recommendation engine for advisor action. Financial transaction data associated with a financial management platform is accessed. The financial transaction data is processed in a probabilistic manner to generate one or more recommendations for financial management actions to be taken by a specified financial advisor for one or more clients of the specified financial advisor, wherein the one or more recommendations are personalized to the specified financial advisor. The one or more ranked recommendations are output.

### BRIEF DESCRIPTION OF THE DRAWINGS

FIG. 1 illustrates a method of providing value based wealth recommendations for advisor action, in accordance with one embodiment.

FIG. 2 illustrates a flow diagram of a system providing a value based wealth recommendation engine for advisor action, in accordance with one embodiment.

FIG. 3 illustrates a method for a statistical correlation evaluation of an estimated prior function, performed by the Action Mining and Prior Estimation module of FIG. 2, in accordance with an embodiment.

FIG. 4 illustrates a method of a Prior Estimation Framework of the Action Mining and Prior Estimation module of FIG. 2, in accordance with an embodiment.

FIG. 5 illustrates a hierarchical relationship between entities which is used by the Quantitative Entity Embedding Creation module of FIG. 2, in accordance with an embodiment.

FIG. 6 illustrates a network architecture, in accordance with one possible embodiment.

FIG. 7 illustrates an exemplary system, in accordance with one embodiment.

### DETAILED DESCRIPTION

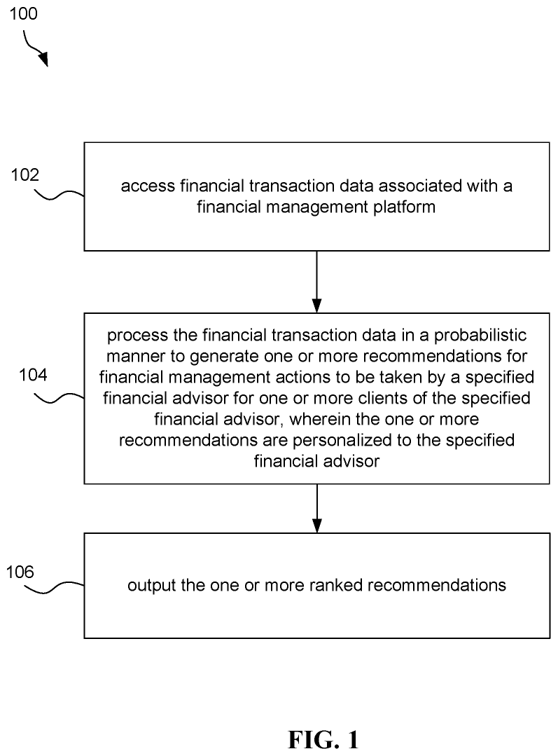

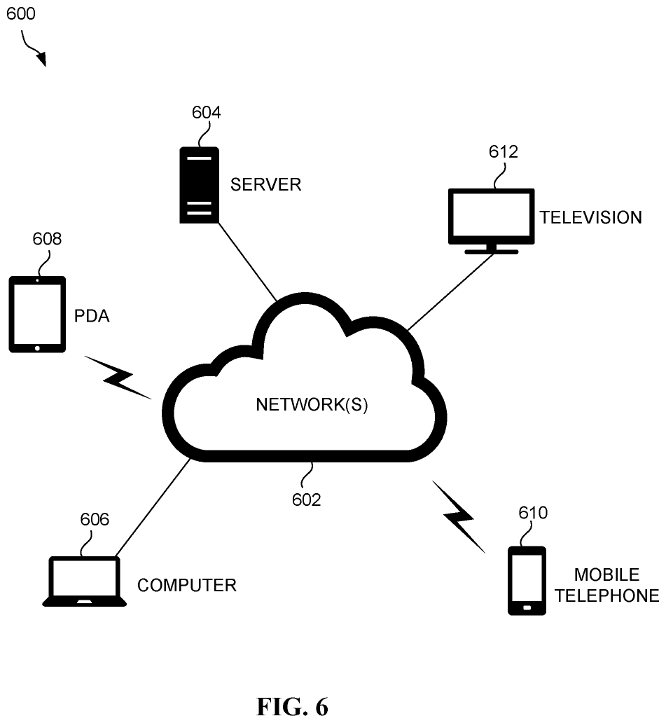

FIG. 1 illustrates a method 100 of providing value based wealth recommendations for advisor action, in accordance with one embodiment. The method 100 may be performed by any computer system, such as those described below with respect to FIGS. 6 and/or 7. In one embodiment, the method 100 may be performed by a computer system on which a financial management platform executes. In another embodiment, the method 100 may be performed by a computer system that interfaces the financial management platform.

With respect to the present description, the financial management platform refers to a platform on which one or more financial management applications execute to manage the finances of various entities (e.g. users and/or businesses). The financial management platform is accessible to financial advisors and enable the financial advisors to manage their clients' wealth and perform necessary actions associated with their holistic financial planning. These actions include (and are not limited to) making decisions for clients' retirement, tax, future expenses, financial goals, wealth creation, risk prevention, estate planning, portfolio management and more.

As mentioned above, the method 100 is performed to provide value based wealth recommendations, which can then be acted upon by the financial advisors. In particular, the recommendations are for financial management actions that can be taken by the financial advisors in order to manage the finances of their clients. This method 100 includes an intelligent process to make financial management-based recommendations to the financial advisors, without necessarily requiring manual input or decision-making from the financial advisors in order to generate such recommendations. This method 100 at least in part streamlines the financial management actions that are taken by the financial advisors, ensuring that any recommended financial management actions are optimal for the financial advisors and their clients.

Returning to the details of the method 100, in operation 102 financial transaction data associated with the financial management platform is accessed. In an embodiment, the financial transaction data may include a plurality of financial management actions supported by the financial management platform. In an embodiment, the financial transaction data may include information associated with financial management actions that have occurred on the financial management platform (e.g. within a predefined past time period).

In operation 104, the financial transaction data is processed in a probabilistic manner to generate one or more recommendations for financial management actions to be taken by a specified financial advisor for one or more clients of the specified financial advisor. In the context of the present operation, the recommendation(s) are personalized to the specified financial advisor.

In an embodiment, the recommendation(s) may be generated in accordance with at least one predefined criterion. For example, the predefined criterion may include prioritizing preferences of the specified financial advisor, prioritizing financial management actions associated with highest dollar values, prioritizing financial management actions with a greatest urgency, prioritizing financial management actions used by other similar financial advisors, etc.

As mentioned, the financial transaction data is processed in a probabilistic manner to generate the financial management action recommendation(s). In an embodiment, the processing may include calculating a prior probability function for each of a plurality of financial management actions supported by the financial management platform. Further to this embodiment, the prior probability function calculated for a financial management action may be configured to estimate a probability that that the financial management action will occur on the financial management platform.

In an embodiment, the processing may include calculating a probability distribution of next financial management actions to recommend to a financial advisor. For example, the probability distribution may be calculated based on contextual domain knowledge. As another example, the probability distribution may be calculated based on sequential correlation between financial management actions supported by the financial management platform.

In an embodiment, the processing may include determining one or more additional financial advisors that are similar to the specified financial advisor. For example, the additional financial advisor(s) may be determined from a knowledge graph, where the knowledge graph is optimized to learn latent representations of financial advisors and clients such that similar entities can be determined therefrom. In an embodiment, similar entities may be determined in terms of their financial attributes.

In an embodiment, the processing may include computing an affinity score for the specified financial advisor towards an opportunity type, financial management action, and client. For example, the affinity score may be computed based on acceptance by the specified financial advisory of prior given recommendations for financial management actions.

In operation 106, the one or more ranked recommendations are output. In an embodiment, the ranked recommendation(s) may be output on a display device for viewing by the specified financial advisory. In an embodiment, the ranked recommendation(s) may be presented to the specified financial advisor in a user interface of the financial management platform. With respect to this embodiment, the user interface may include functionality allowing the specified financial advisor to cause a select financial management action to be automatically performed by the financial management platform. For example, specified financial advisor may select one of the recommended financial management actions, which in turn may cause the financial management platform to automatically perform such action.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

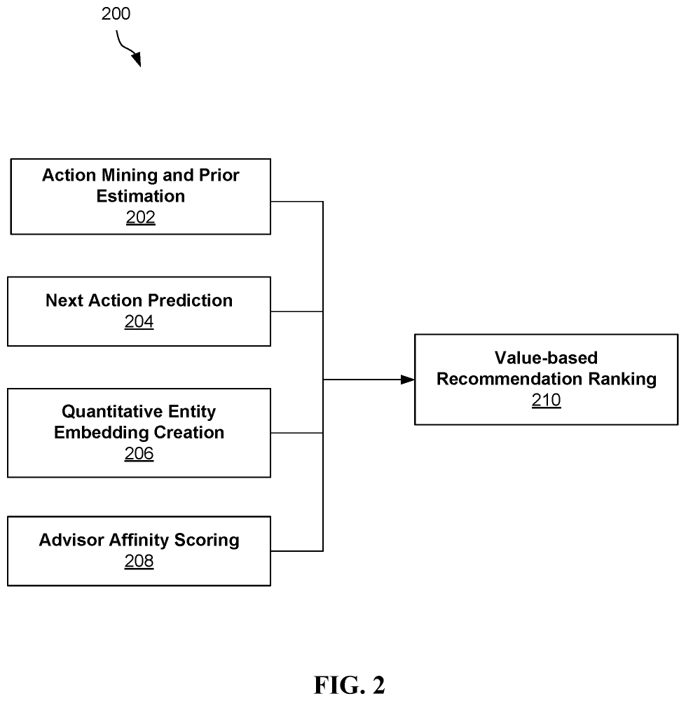

FIG. 2 illustrates a flow diagram of a system 200 providing a value based wealth recommendation engine for advisor action, in accordance with one embodiment. As an option, the system 200 may be implemented in the context of the details of the previous figure and/or any subsequent figure(s). Further, the aforementioned definitions may equally apply to the description below.

It should be noted that while various components of the system 200 are described herein, the system 200 is not necessarily limited to such components. Moreover, the components of the system 200 may be implemented in hardware, software, or any combination thereof.

The system 200 is configured to learns and recommend the most suitable financial management action a financial advisor can take for the benefit of their client to achieve their goals. The system 200 architecture is divided into five modules:

Action Mining and Prior Estimation 202: Mine all the actions that can be taken on the platform and calculate the prior probability of those actions in particular states.

Next Action Prediction 204: Develop a system that predicts the next best action by learning from sequential associations and applying contextual domain knowledge.

Quantitative Entity Embedding Creation 206: Learn advisor, client, account, and portfolio embeddings from a knowledge graph-based architecture.

Advisor Affinity Scoring 208: Learn the priorities and affinities of each advisor towards their clients, actions, recommendations to increase the probability of recommendation acceptance.

Value-based Recommendation Ranking 210: Build an engine that ranks recommendations in the order of their perceived value to the advisor for a client.

These system modules 202-210 are described in detail as follows.

### Action Mining and Prior Estimation 202

Goal: The goal of this module 202 is to mine all the different actions that can take place on the financial management platform and assign a prior probability to each action through a prior framework.

### Action Mining System

The action mining system maintains and adds to the list of actions that can be taken on or identified from the financial management platform which include (and are not limited to) trading, communicating, portfolio rebalancing, adding an account-related-service, tax harvesting, and report generation. Actions that are not originally taken on the platform are also mined and inferred through topic modelling techniques on transaction descriptions, activities on aggregated accounts, service requests, and textual activity notes.

### The Prior Framework

This prior is defined as the natural probability for an action to occur without any personal context. It can be defined as a constant value or a function of historical values. Once an action is mined, a prior is estimated for that action. The prior allows the system 200 to:

1. Understand the prevalent sentiment, seasonality, and other generalizable traits of the platform for a particular action.

2. Calculate the affinity of an advisor towards a particular action and estimate the value of the action to be recommended.

The prior function can be defined at three levels:

1. Global prior—Global Priors are calculated for the most generalized actions at macro level.

Example: buy, sell, account opening, closing, advisor firing, status changing, cash in etc.

2. Nested Priors—Nested Priors are for actions that can be generalized further. Example: ‘buy mutual fund’, ‘buy annuity’, ‘retirement account opening’.

3. Conditional Priors—Conditional priors are used when the history of actions is not sufficient to calculate the prior (action depends on other actions/events) or we want to calculate the prior given some condition. These probabilities are calculated using bayes theorem.

Example: Buy of security X|market price of X, Fees paid|billing report created, Add tax overlay|tax paid, Sell of X|time held X.

The prior can also be calculated for a context or subgroup such as demographic (clients in a certain region), behavioral (clients with high-risk appetite) or segmental (clients enrolled in a certain program).

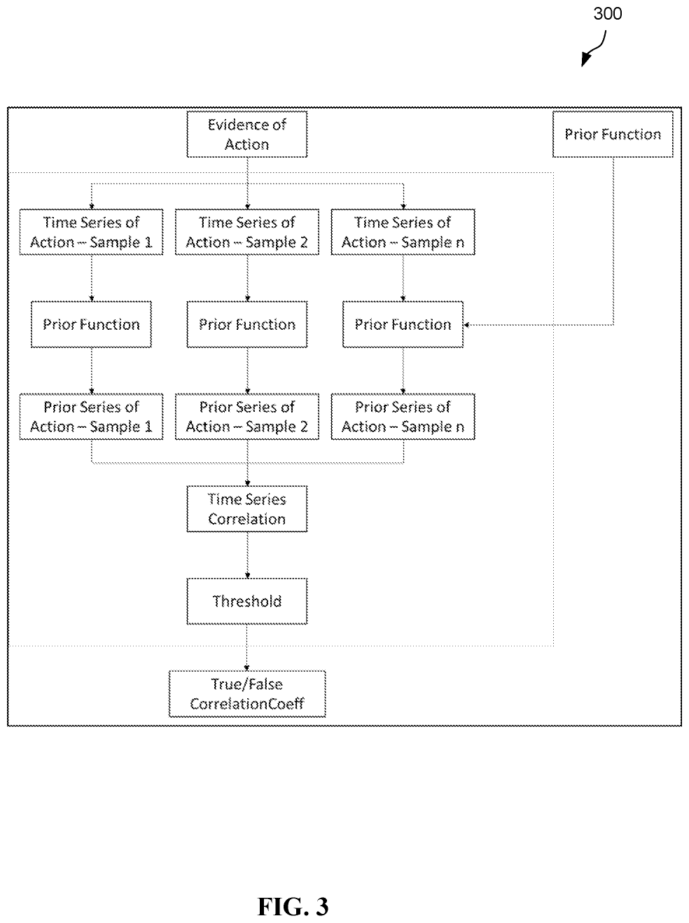

To evaluate whether the prior function represents the natural probability of occurrence of the action, we use the following statistical correlation (see FIG. 3) among the time series of priors calculated for different subsets of evidence for all time steps in history:

1. The prior function estimated time series for the subsets should be statistically significantly correlated.

2. The standard deviation between the values of the prior function estimated time series should not be greater than a threshold or the p-value (score of correlation between samples occurring due to chance) should be less than a threshold.

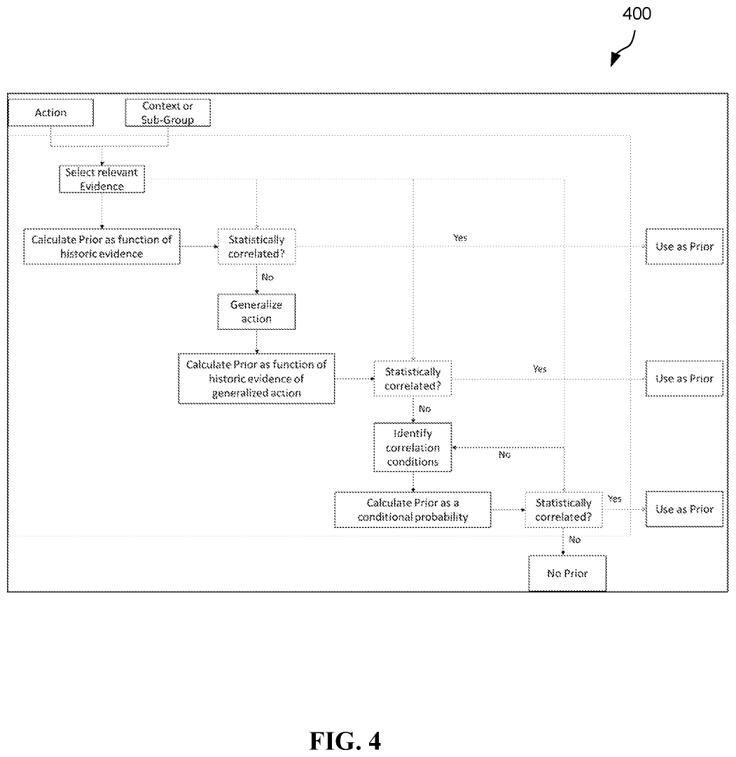

FIG. 4 illustrates a method 400 of the Prior Estimation Framework of the Action Mining and Prior Estimation module 202, as described above.

This module 202 returns a list of all actions and an estimated prior probability function for each action: Prior(Action)

### Next Action Prediction 204

The goal of this module 204 is to combine contextual domain knowledge and sequential correlation between actions to calculate the probability distribution of next actions that can be recommended to the financial advisor to capitalize on an opportunity. The module is divided into 2 main parts: Contextual next actions and Sequential next actions.

### Contextual Next Actions

Contextual next action is defined as an action that can be recommended to an advisor given a context. This context can be deterministic or probabilistic financial conditions that create an opportunity for the advisor to exploit. These contexts stem from subject matter expertise and domain knowledge.

The contextual next actions serve as actions that need to be taken to sustain client portfolio health and strengthen advisor-client relationship. These actions inform advisors about regular financial cycles, important performance metrics, key client updates etc. so that advisor is better prepared for their goals and tasks.

Example 1. The context is—“Tax filing for the FY'23 is due next month for the client”, the next action is “File taxes for the client portfolio of $30,000 by the end of the month.”, the opportunity for the advisor with this action is to “Optimize Tax”, the Dollar Value is estimated as a percentage of assets (30%): “$9000”

In this example, the context and the probability for the next action are defined by business rules. A list of such rules is maintained and updated regularly.

Example 2. The context is—“Estimated risk in client portfolio due to market events has increased by a threshold percent.”, the next action is “Alert the advisor to review the risk on client portfolio of $30,000.”, and the opportunity is “Optimize Risk”, the Dollar Value is estimated as a percentage of assets (10%) “$3000”

In this example, the context and the probability of action are defined by threshold probabilities and their ranges vary with business context.

### Sequential Next Actions

Sequential next action is a predictive machine learning module that learns from the patterns and experiences of financial advisors over the years and inform the advisor of opportunities that have been capitalized in the past by other advisors in the network.

Financial events and actions are complex and correlated with each other. Sometimes there is a cause-effect relationship between certain actions and events. These events can be at different levels, including and not limited to financial, personal, or firm level. For example, ‘a medical event in a client's life’ is a personal event and ‘dividends received in an account’ is a financial event. These actions and events are mined and stores as sequences.

Example Sequence: advisor buys stock x (action)→advisor notifies client of purchase (action)→client confirms purchase (action)→client adds cash to account (action)→advisor contacts client (action)→dividends of x received (event)→advisor sells x at a profit (action)→gains realized in account (event)→quarterly report generated (event)

A sequential model is trained to learn correlations, patterns, and associations between actions and events. Conditional probabilities are inherently learnt by the model from a huge number of sequences it is trained upon. From the sequential model, the actions that help capitalize on an opportunity are identified and vetted using business knowledge. The opportunities from the output of sequential action module are carefully curated, vetted, and constrained to certain opportunity types that intend high level optimization instead of any investment recommendation.

Example 1. The model learns from the following sequences of actions:

“advisor sells stock x (action)→capital gain worth $1000 (event)”

that the next best action for the advisor is:

“Consider selling a portion of underperforming stock at a loss of $1000 to minimize capital gains tax”

In this example, the action “Selling underperforming stock” serves the opportunity to “Minimize Tax”, and Dollar Value is “$1000”

Example 2. The model learns from the following sequences of actions:

“$2000 cash added in account A (action)→dividend worth $500 received in account A (event)”that the next best action for the advisor is:

“consider investing portion of $2500 in existing position of account A for dollar cost averaging”

In this example, the action “Invest in existing position” serves the opportunity to “Dollar cost averaging”, and Dollar Value is “$2500”

This module 204 returns a probability distribution of next actions that can be recommended to the advisor for a client combining both contextual and sequential models and the dollar value of the opportunity they serve: ProbDist (Next Action, Opportunity), DollarValue(Opportunity)

### Quantitative Entity Embedding Creation 206

The goal of this module 206 is to learn quantitative representations for advisors and clients that incorporates all the platform information and can be used to find similar advisors and similar clients.

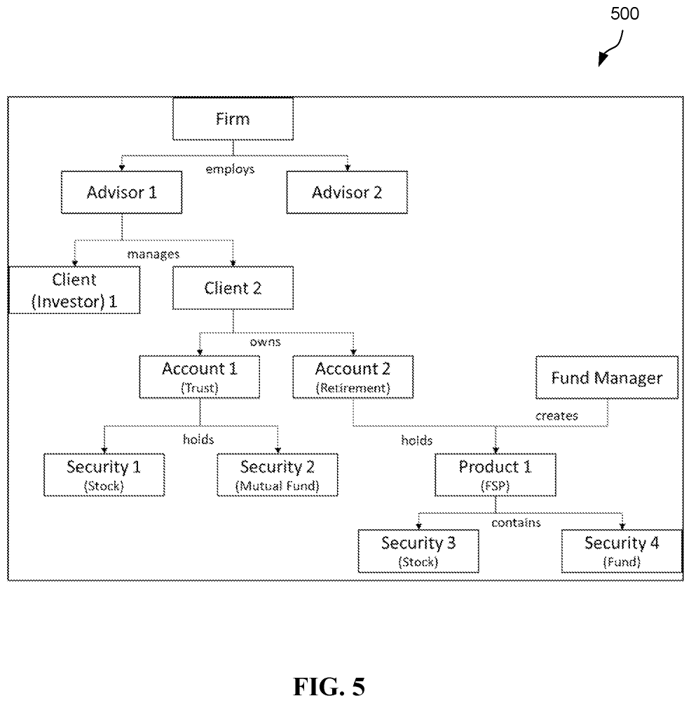

The investment data landscape has many entities which are related to each other though some relationship. These relationships between these entities are hierarchical in nature. FIG. 5 describes these hierarchical relationships. A graph data structure is chosen to represent this data and knowledge graph completion algorithms are trained to learn from this graphical structure for 3 primary reasons.

1. Hierarchical entities and relations are easily represented in the form of nodes and edges respectively in knowledge graphs.

2. Sparse information can be passed, and missing links can be predicted from this structure.

3. Quantitative vector representation of entities can be learnt from the knowledge graphs that incorporates granular network level interactions and information.

The knowledge graph is optimized to learn latent representations of advisors and clients such that similar entities in terms of their financial attributes such as: asset allocation style, frequency of trade frequency, choice of products/securities/fund managers, client distribution, demography and more, end up close to each other in the n-dimensional space.

This module 206 returns for any advisor, the k nearest neighbors (similar advisors) based on cosine similarity of their knowledge graph embeddings: KNearestNeighbors(Advisor)

### Advisor Affinity Scoring 208

The goal of this module 208 is to assign an affinity score (or likelihood of acceptance) for each advisor towards an opportunity type, action, and a client by learning from their usage of the recommendations presented to them.

Affinity score is defined for an advisor as the probability (or likelihood) of them acting towards a particular action, client, or opportunity.

Financial advisors have different priorities and inclinations. One advisor might be more interested in saving tax, while other might be more interested in increasing client wealth. And advisors might also have different priorities for different clients. To increase the probability that an advisor acts on the recommendation presented to them, more suitable and high priority recommendation must be presented first. In this module 208 these priorities are learned through a set of affinity scores, which further can be used as conditional probabilities together.

In an exemplary embodiment, a seed set of 20 million recommendations from both sequential and contextual models were presented to 30 k advisors. Each individual recommendation to an advisor has certain characteristics:

1. It has an Opportunity Type

2. It has a Call to Action

3. It has a Dollar Value assigned to it.

4. It is personalized for one of their clients.

An Opportunity can have multiple actions associated with it as expressed by the following two examples:

Example 1.—“Sell underperforming security X in Mr. Haverford's brokerage account to harvest tax worth $3000.”

In this example, Opportunity is “Harvest Tax”, Recommended Action is “Sell security X”, Dollar Value is “$3000” and client is “Mr. Haverford”

Example 2.—“Add Tax overlay service to Mr. Bill's retirement account to harvest tax worth $16000.”

In this example, Opportunity is “Harvest Tax”, Recommended Action is “Add Tax Overlay Service”, Dollar Value is “$16000” and client is “Mr. Bill”

### Affinity Score Calculation

A recommendation is said to have been accepted and acted upon by the advisor if a click is recorded on the platform and the advisor takes the recommended action on it in the next n days. For every action we also have a prior calculated from our prior framework that represents the natural probability of that action to take place. The prior contributes towards the action being taken, so to identify if the action was taken because of the recommendation a factor of (1—prior (action)) is used. The likelihood of the advisor acting on a particular opportunity/action signals towards their priorities and interests as an advisor.

An advisor's affinity towards an opportunity type and an action is calculated by the following Equation 1.

$$Equation 1$$

$$Affinity ( Advisor , Opportunity ) = {\sum }_{a} ( {N}_{a} * ( 1 - prior ( {action}_{a} ) ) ) / {\sum }_{a} {T}_{a}$$

$$Affinity ( Advisor , Action ) = ( {N}_{a} * ( 1 - prior ( {action}_{a} ) ) ) / {T}_{a}$$

Tₐ=Total number of recommendations with actionₐ presented to the advisor
   Nₐ=Number of times the advisor acted upon the recommended actionₐ
a∈Set of all the actions being recommended under the opportunity type
   prior(actionₐ)=Prior probability of actionₐ
      Affinity (Advisor, Client)=N_{c}/T_{c}
T_{c}=Total number of recommendations presented to the advisor for client_{c}
   N_{c}=Number of times the advisor acted upon the recommendation for clientc

### Estimated Affinity Score

The output of Quantitative Entity Embedding Creation module-KNearestNeighbors(Advisor) is used to approximate Affinity scores for advisor's who have not received enough recommendations to create a reasonable and statistically significant estimate for their affinity towards an opportunity type or action. Their affinity scores are calculated as a function of their “k similar advisor's affinity scores” per Equation 2.

$$Affinity ( Advisor , O / A ) = {\sum }_{k} Affinity ( {Advisor}_{k} , O / A ) / K \qquad Equation 2$$

O/A=Opportunity or Action
   K=Number of similar advisors taken for estimation
   Advisorₖ=kth nearest advisor from KNearestNeighbors(Advisor)

### Joint Affinity Score

Joint Affinity for advisor to act on an opportunity type for a particular client is calculated by Equation 3.

$$Equation 3$$

$$Affinity ( Advisor , Opportunity , Client ) = {\sum }_{a} ( {N}_{ac} * ( 1 - prior ( {action}_{a} ) ) ) / {\sum }_{a} {T}_{ac}$$

$$Affinity ( Advisor , Action , Client ) = ( {N}_{ac} * ( 1 - prior ( {action}_{a} ) ) ) / {T}_{ac}$$

T_{ac}=Total number of recommendations of opportunity type presented to the advisor for client_{c}
N_{ac}=Number of times the advisor acted upon the recommendation of opportunity type for client_{c}

### Conditional Affinity Score

Conditional Affinity is then calculated using Bayes theorem such that the probability of advisor accepting a recommendation with an opportunity/action given a particular client can be calculated per Equation 4.

$$Equation 4$$

$$Affinity ( Advisory , O / A \vert Client ) = Affinity ( Advisor , O / A , Client ) / Affinity ( Advisor , Client )$$

In cases where there isn't enough evidence, Conditional Affinity for an advisor to act on an opportunity given a particular client can be estimated by Equation 5.

$$Equation 5$$

$$Affinity ( Advisor , \text{} O / A \vert Client = Affinity ( Advisor , Client ) * Affinity ( Advisor , O / A )$$

This module 208 returns the affinity or likelihood of an advisor to act upon a certain type of opportunity, action and client: Affinity (Advisor, Opportunity), Affinity (Advisor, Opportunity|Client), Affinity (Advisor, Action), Affinity (Advisor, Action|Client), Affinity (Advisor, Client)

### Value-Based Recommendation Ranking 210

The goal of this module 210 is to combine the outputs of all modules 202-208 to create a ranked set of recommendations for an advisor in the order of perceived value to the advisor. The success metric is the advisor acting on the highly ranked recommendations and increases their engagement with the recommendation engine.

Ranked Recommendations=Function (ProbDist(Next Action, Opportunity), Affinity(Opportunity, Client), Affinity(Action, Client), Affinity(Advisor, Opportunity|Client), Affinity(Advisor, Action|Client), Affinity(Advisor, Client), DollarValue(Opportunity), Prior(Action))

The function internally selects and updates the most appropriate Affinity scores to be incorporated to rank the next actions to serve an opportunity. The system 200 is designed in a way that the most important recommendations in terms of the following criterions may rank higher in the ranking, per a desired configuration:

1. The recommended actions are not obvious actions (Prior for those actions are low).

2. The actions are for the most important clients of the advisor.

3. The opportunities are priorities of the advisor.

4. Higher dollar value is associated with the recommendations.

5. The actions are more urgent in nature.

6. The network of similar advisors have capitalized on similar opportunities.

The system 200 returns a set of value-driven ranked recommendations for advisors personalized towards their clients. This system 200 is continuously updated and improved with the feedback from advisors using the system 200. It is probabilistic in nature, is directed towards the advisors, and the final decision lies in the hands of the advisor.

FIG. 6 illustrates a network architecture 600, in accordance with one possible embodiment. As shown, at least one network 602 is provided. In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 604 and an end user computer 606 may be coupled to the network 602 for communication purposes. Such end user computer 606 may include a desktop computer, lap-top computer, and/or any other type of logic. Still yet, various other devices may be coupled to the network 602 including a personal digital assistant (PDA) device 608, a mobile phone device 610, a television 612, etc.

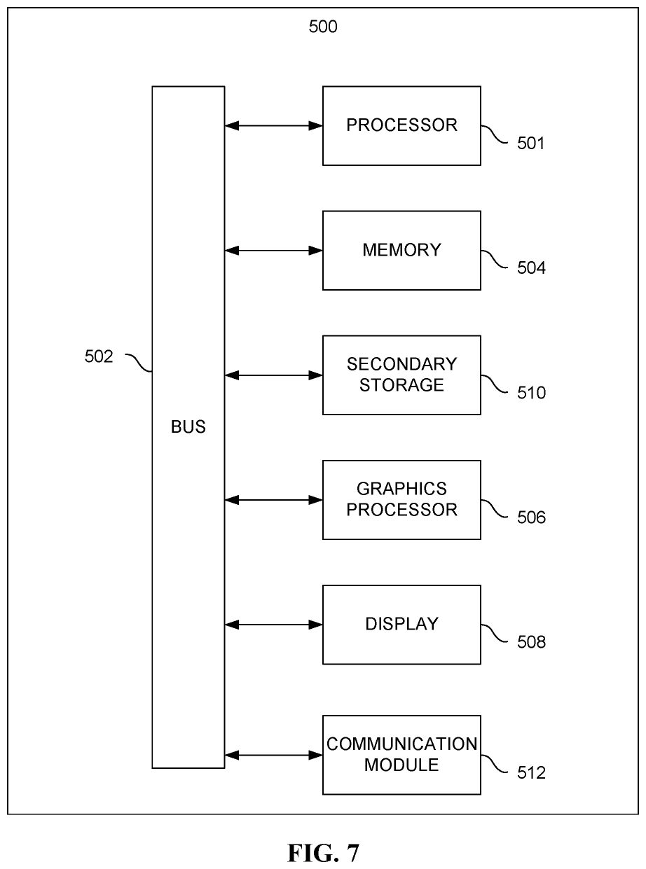

FIG. 7 illustrates an exemplary system 700, in accordance with one embodiment. As an option, the system 700 may be implemented in the context of any of the devices of the network architecture 700 of FIG. 7. Of course, the system 700 may be implemented in any desired environment.

As shown, a system 700 is provided including at least one central processor 701 which is connected to a communication bus 702. The system 700 also includes main memory 704 [e.g. random access memory (RAM), etc.]. The system 700 also includes a graphics processor 706 and a display 708.

The system 700 may also include a secondary storage 710. The secondary storage 710 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 704, the secondary storage 710, and/or any other memory, for that matter. Such computer programs, when executed, enable the system 700 to perform various functions (as set forth above, for example). Memory 704, storage 710 and/or any other storage are possible examples of non-transitory computer-readable media.

The system 700 may also include one or more communication modules 712. The communication module 712 may be operable to facilitate communication between the system 700 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
access financial transaction data associated with a financial management platform;
process the financial transaction data in a probabilistic manner to generate one or more recommendations for financial management actions to be taken by a specified financial advisor for one or more clients of the specified financial advisor, wherein the one or more recommendations are personalized to the specified financial advisor; and
output the one or more ranked recommendations.

2. The non-transitory computer-readable media of claim 1, wherein the financial transaction data includes a plurality of financial management actions supported by the financial management platform.

3. The non-transitory computer-readable media of claim 1, wherein the financial transaction data includes information associated with financial management actions that have occurred on the financial management platform.

4. The non-transitory computer-readable media of claim 1, wherein processing the financial transaction data includes:
calculating a prior probability function for each of a plurality of financial management actions supported by the financial management platform, wherein the prior probability function calculated for a financial management action is configured to estimate a probability that that the financial management action will occur on the financial management platform.

5. The non-transitory computer-readable media of claim 1, wherein processing the financial transaction data includes:
calculating a probability distribution of next financial management actions to recommend to a financial advisor.

6. The non-transitory computer-readable media of claim 5, wherein the probability distribution is calculated based on contextual domain knowledge.

7. The non-transitory computer-readable media of claim 5, wherein the probability distribution is calculated based on sequential correlation between financial management actions supported by the financial management platform.

8. The non-transitory computer-readable media of claim 1, wherein processing the financial transaction data includes:
determining one or more additional financial advisors that are similar to the specified financial advisor.

9. The non-transitory computer-readable media of claim 8, wherein the one or more additional financial advisors are determined from a knowledge graph, and wherein the knowledge graph is optimized to learn latent representations of financial advisors and clients such that similar entities can be determined therefrom.

10. The non-transitory computer-readable media of claim 9, wherein similar entities are determined in terms of their financial attributes.

11. The non-transitory computer-readable media of claim 1, wherein processing the financial transaction data includes:
computing an affinity score for the specified financial advisor towards an opportunity type, financial management action, and client.

12. The non-transitory computer-readable media of claim 11, wherein the affinity score is computed based on acceptance by the specified financial advisory of prior given recommendations for financial management actions.

13. The non-transitory computer-readable media of claim 1, wherein the one or more recommendations are generated in accordance with at least one predefined criterion.

14. The non-transitory computer-readable media of claim 13, wherein the at least one predefined criterion includes prioritizing preferences of the specified financial advisor.

15. The non-transitory computer-readable media of claim 13, wherein the at least one predefined criterion includes prioritizing financial management actions associated with highest dollar values.

16. The non-transitory computer-readable media of claim 13, wherein the at least one predefined criterion includes prioritizing financial management actions with a greatest urgency.

17. The non-transitory computer-readable media of claim 13, wherein the at least one predefined criterion includes prioritizing financial management actions used by other similar financial advisors.

18. The non-transitory computer-readable media of claim 1, wherein outputting the one or more ranked recommendations includes:
presenting, to the specified financial advisor, the one or more ranked recommendations in a user interface of the financial management platform;
wherein the user interface includes functionality allowing the specified financial advisor to cause a select financial management action to be automatically performed by the financial management platform.

19. A method, comprising:
at a computer system:
accessing financial transaction data associated with a financial management platform;
processing the financial transaction data in a probabilistic manner to generate one or more recommendations for financial management actions to be taken by a specified financial advisor for one or more clients of the specified financial advisor, wherein the one or more recommendations are personalized to the specified financial advisor; and
outputting the one or more ranked recommendations.

20. A system, comprising:
a non-transitory memory storing instructions; and
one or more processors in communication with the non-transitory memory that execute the instructions to:
access financial transaction data associated with a financial management platform;
process the financial transaction data in a probabilistic manner to generate one or more recommendations for financial management actions to be taken by a specified financial advisor for one or more clients of the specified financial advisor, wherein the one or more recommendations are personalized to the specified financial advisor; and
output the one or more ranked recommendations.
